(19) United States
(12) Patent Application Publication
(10) Pub. No.: US 2007/0251638 A1
(43) Pub. Date: Nov. 1, 2007

(54) Method and composition for the adhesion of materials

(75) Inventor: Jean J. Robillard, El Paso, TX (US)

Correspondence Address: PEACOCK MYERS, P.C., 201 THIRD STREET, N.W., SUITE 1340, ALBUQUERQUE, NM, 87102, US

(73) Assignee: Quantum Research of America Inc., El Paso, TX (US)

(21) Appl. No.: 11/410,571

(22) Filed: Apr. 24, 2006

(51) Int. Cl. B32B 37/12; H05B 6/68; G03C 1/00

(52) U.S. Cl. 156/275.7; 156/275.5; 430/270.1; 522/1

(57) ABSTRACT

A method and composition for the adhesion of materials to one another, particularly for adhering soles onto shoes. The present invention utilizes the photochemical properties of resins to polymerize under the influence of x-rays to form an adhesive structure, specifically a cross-linking structure.

### BACKGROUND OF THE INVENTION

1. Field of the Invention (Technical Field)

The present invention relates to a method and formulation for the adhesion of materials to one another, particularly to a method and formulation for gluing soles onto shoes.

2. Description of Related Art

Note that the following discussion refers to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

The process typically used for gluing many material substrates together, such as soles onto shoes, whether of synthetic or natural materials, is a thermal process based on the heating of a polymer material to initiate polymerization or cross-linking of the polymer material thus resulting in the adhesion of the sole to the main body of the shoe. However, because of the complicated geometry of the substrates and/or the polymer material, the transfer of heat is not homogenous, and the penetration of heat reaching surfaces varies from one point to another thus resulting in a product of low quality. Further, such thermal processes involve a relatively long gluing time and production process.

There is therefore a need to better, and more quickly, adhere material substrates, such as a sole and a shoe, together.

### BRIEF SUMMARY OF THE INVENTION

The present invention provides an adhesive, photosensitive composition that is polymerizable upon exposure to x-rays. The composition is applicable for adhering substrates comprising a variety of materials such as, but not limited, to the adhesion of a footwear upper to a sole.

Thus, an embodiment of the present invention comprises an adhesive, photosensitive composition comprising a first compound comprising a monomer, a crosslinkable polymer, or a combination thereof, and a second compound that generates free radicals capable of initiating polymerization upon exposure to a source of x-rays. The monomer is preferably polymerizable. Preferably, the polymer forms cross links and the monomer polymerizes upon exposure to x-rays.

Preferably, the second compound comprises, but is not limited to, boron trifluoride di-ethyletherate, paratoluenesulfonic acid, 2,2 azobis(2methyl propionitrile), or a combination thereof.

Preferably, the composition further comprises a solvent, and preferably further comprises a binder soluble in the solvent. The binder preferably comprises a binder polymer comprising, but not limited to, polyurethanes, polystyrenes, polybutadienes, copolymers of styrene, butadienes, or a combination thereof. The binder polymer is preferably hydrophobic and not photodegradable by x-rays.

Preferably, the cross linkable polymer and said monomer are present in the composition in a ratio of from between approximately 35 and 22:1, respectively.

Preferably, the monomer and the crosslinkable polymer comprise polymers such as, but not limited to, polyacrilics, polystyrenes, polyvinylesthers, spiroorthoesthers, bicicloorhoesthers, their co-polymers, or a combination thereof.

Preferably, the monomer comprises, but is not limited to, a polyacrilate selected from the group consisting of methylmethacrylate, allylmethacrylate, hydroxyethylmethacrylate, dichloropropylacrylate, phenylmethacrylate, acrylic acid, ethylacrylate, glycidylmethacrylate, or a combination thereof. The monomer may comprise a chloromethylstyrene. The monomer may also preferably comprise a polyvinylesther comprising, but not limited to, 2-chloroethylvinylether, ethylvinylether, isobutylvinylether, vinylferrocene, or a combination thereof. The monomer may also preferably comprise, but is not limited to, spiroorthoesthers, bicicloorthoesters, or a combination thereof. Preferably, such a spiroorthoesther comprises, but is not limited to, 2-hydroxymethyl-1,4,6-trioxaspiro[4,6]undecane, 2-methylene-1,4,6-trioxaspiro[4,6]undecane, 2-allyloxymethyl-1,4,6-trioxaspiro[4,6]undecane, 2-methacryloxymethyl-1,4,6-trioxaspiro[4,6]undecane, or a mixture thereof. Preferably, such a bicicloorthoesther comprises, but is not limited to, 1-ethyl-4-hydromethyl-2,6,7-trioxabiciclo[2,7,7]octane, 4-ethylvinyl-2,6,7-trioxabiciclo[2,7,7]octane, or a combination thereof.

The monomer may also preferably comprise, but is not limited to, butane-1-sulfone, di-allylorthophtalate, or a combination thereof.

Preferably, the crosslinkable polymer comprises, but is not limited to, polymethacrylate, polyhydroxyalkylmethacrylate, polyphenylamethacrylate, acrylic acid, polyallylmethacrylate, polyhydroxyethylmethacrylate, polyglycidilmethacrylate, polyethylacrylate, Zn polymethacrylate, polydiaryl-ophtalmic acid, Zn acrylate, triarylisocyanurate, or a combination thereof.

Another embodiment of the present invention comprises a method for adhering materials together, said method comprising combining a first compound comprising a monomer, a crosslinkable polymer, or a combination thereof with a second compound that generates free radicals capable of initiating polymerization upon exposure to a source of x-rays to form a photosensitive compound, disposing the photosensitive composition between two substrates to be adhered to one another, and

exposing the photosensitive composition to x-rays so that the photosensitive compound polymerizes to adhere the two substrates together. The method preferably further comprises disposing the photosensitive composition between the two substrates in a layer of from between approximately 60 and 200 microns. The method preferably further comprises exposing the photosensitive composition to x-rays from an x-ray source of approximately 6 kV and 12 mA, of a dose of approximately 0.03 Joules, and/or for a time of from between approximately 50 microseconds to 4 seconds.

Another embodiment comprises an assembly comprising a first material, a second material, and a photosensitive adhesive composition disposed between the first material and the second material, said photosensitive adhesive composition polymerizable upon exposure to x-rays. The photosensitive adhesive composition preferably comprises a first compound comprising a polymerizable monomer, a crosslinkable polymer, or a combination thereof, said monomer polymerizable upon exposure to x-rays and said polymer crosslinkable upon exposure to x-rays, and a second compound that generates free radicals capable of initiating polymerization upon exposure to a source of x-rays. The assembly may comprise footwear wherein the first material comprises a footwear upper material and the second material comprises a footwear sole.

A primary object of the present invention is to efficiently adhere material substrates together to produce a product of a quality higher than that achieved using heat.

A primary advantage of the present invention is that soles can be efficiently adhered to shoes resulting in a product of higher quality than that achieved using heat

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### DETAILED DESCRIPTION OF THE INVENTION

The present invention provides a method and composition for the adhesion of materials to one another, particularly for gluing soles onto shoes. The present invention utilizes the photochemical properties of resins to polymerize under the influence of x-rays. As used in the specification and claims herein, the terms “a”, “an”, and “the” mean one or more.

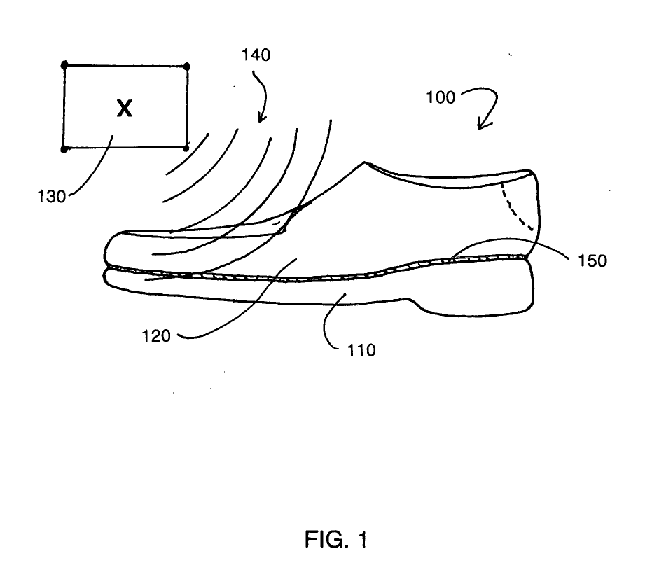

Thus, an embodiment of the present invention comprises applying, between surfaces of materials to be adhered to one another, at least one layer of a photosensitive composition. Although an embodiment, shown in FIG. 1, of the method and formulation described herein is applicable to gluing soles onto footwear (e.g., shoes), the invention can be applied to the adhesion of any materials, synthetic and natural, of the type typically used in footwear yet found in other fields and in other applications of use. Thus, illustrative of the various embodiments within the scope of the present invention is the embodiment shown in FIG. 1 wherein shoe 100 is shown comprising a first material substrate (shoe upper 120) and a second material substrate (sole 110). Photosensitive composition 150 is disposed (sandwiched) between shoe upper 120 and sole 110. X-ray source 130 then delivers x-rays 140 to photosensitive composition 150 to cause the polymerization of photosensitive composition 150 and thus the adhesion of shoe upper 120 to sole 110.

In an embodiment of the invention, the photosensitive composition preferably comprises at least one monomer, at least one crosslinkable polymer, or a mixture thereof and at least one compound that generates free radicals capable of initiating polymerization upon exposure to a source of x-rays. The composition may further be present in, or comprise, at least one binder and/or at least one solvent.

The monomer utilized in the present invention is preferably one that is polymerizable to form an adhesive structure between the substrates to be adhered to one another. The polymer utilized is preferably one that comprises reactive links that crosslink to form an adhesive structure between the substrates to be adhered to one another. Polymerization and cross-linking is activated upon exposure to x-rays.

The compound utilized in the present invention to generate free radicals preferably comprises boron trifluoride di-ethyletherate, paratoluenesulfonic acid, 2,2 azobis(2methyl propionitrile), or a combination thereof.

The photosensitive composition preferably, but not necessarily, comprises an emulsion or a solution in a binder, and the solution may comprise at least one solvent in which the binder is soluble. The binder comprises a polymer, preferably including, but not limited to, polyurethanes, polystyrenes, polybutadienes, copolymers of styrene and butadienes, or mixtures thereof. The polymer is hydrophobic and not photodegradable by x-rays.

The concentration of each of the monomer, polymer, free radical generator, binder, and solvent may vary to accomplish their respective functions in the manner commonly understood in the art. When the formulation comprises both a polymer and a monomer, the ratio of polymer to monomer utilized is preferably from between approximately 35 and 22 to 1, respectively (i.e., the composition comprising from between approximately 2.9% and 4.5% monomer), more preferably from between 30 and 23 to 1 (i.e., the composition comprising from between approximately 3.3% and 4.4% monomer), and still more preferably approximately 24 to 1 (i.e., approximately 96% polymer and approximately 4.2% monomer).

The photosensitive composition is disposed over the two material substrates to be adhered to one another in a layer of preferably between approximately 60 and 200 microns. The composition is preferably submitted to a pressure sufficient to keep the substrates in contact during exposure to x-rays. The exposure time is a function of the substances used in the composition and the intensity of the x-rays. Such exposure may vary from milliseconds to seconds. Preferably the source of x-rays is approximately 6 kV, 12 mA, and the dose is preferably of approximately 0.03 Joules for between approximately 50 microseconds and 4 seconds, more preferably for between approximately 1 millisecond and 2 seconds, still more preferably from between 10 milliseconds and 2 seconds, and still more preferably from between 50 milliseconds and 2 seconds.

The monomers and crosslinkable polymers include, but are not limited to, polymers such as polyacrilics, polystyrenes, polyvinylesthers, spiroorthoesthers, bicicloorhoesthers, their co-polymers, or mixtures thereof. These are described in more detail below.

The monomers comprising polyacrylates preferably include, but are not limited to, methylmethacrylate, allylmethacrylate, hydroxyethylmethacrylate, dichloropropylacrylate, phenylmethacrylate, acrylic acid, ethylacrylate, glycidylmethacrylate, or mixtures thereof.

The monomers comprising polystyrenes preferably comprise, but are not limited to, chloromethylstyrenes.

The monomers comprising polyvinylesthers include, but are not limited to, 2-chloroethylvinylether, ethylvinylether, isobutylvinylether, vinylferrocene, or mixtures thereof.

The monomers of high sensitivity to x-rays may include, but are not limited to the spiroorthoesthers and the bicicloorthoesters. The spiroorthoesthers preferably include, but are not limited to, 2-hydroxymethyl-1,4,6-trioxaspiro[4,6]undecane, 2-methylene-1,4,6-trioxaspiro[4,6]undecane, 2-allyloxymethyl-1,4,6-trioxaspiro[4,6]undecane, 2-methacryloxymethyl-1,4,6-trioxaspiro[4,6]undecane, or mixtures thereof. The bicicloorthoesthers preferably include, but are not limited to, 1-ethyl-4-hydromethyl-2,6,7-trioxabiciclo[2,7,7]octane, 4-ethylvinyl-2,6,7-trioxabiciclo[2,7,7]octane, or mixtures thereof.

Other monomers that may be utilized include, but are not limited to, butane-1-sulfone, di-allylorthophtalate, or mixtures thereof.

The crosslinkable polymers comprise, but are not limited to, polymethacrylate, polyhydroxyalkylmethacrylate, polyphenylamethacrylate, acrylic acid, polyallylmethacrylate, polyhydroxyethylmethacrylate, polyglycidilmethacrylate, polyethylacrylate, Zn polymethacrylate, polydiaryl-ophtalmic acid, Zn acrylate, triarylisocyanurate, or mixtures thereof.

The uniform penetration of x-rays through the shoe material produces a continuous adhesion and rapid polymerization that is faster in relation to the typical thermal processes.

### EXAMPLES

The following examples are conducted in accordance with the present invention:

1. A solution of 1-ethyl-4-methacryloxymethyl-2,6,7-tryioxabiciclo[2,2,2]octane in methylcellosolve acetate is deposited over material substrate surfaces. The substrates are kept in contact via exposure to pressure and exposed to an x-ray dose of approximately 0.03 Joules from an x-ray source of 6 kV, 12 mA, for between approximately 2 milliseconds and 2 seconds.

2. A solution of 2-methylene-1,4,6-trioxaspiro[4,6]undecane in benzonitile is deposited over substrate surfaces. The substrates are kept in contact via exposure to pressure and exposed to an x-ray dose of approximately 0.03 Joules from an x-ray source of 6 kV, 12 mA, for between approximately 2 milliseconds and 2 seconds.

3. A solution of 1-ethyl-4-vinylbenzyloxymethyl-2,6,7-trioxabiciclo[2,2,2]octane in toluene is deposited over substrate surfaces. The substrates are kept in contact via exposure to pressure and exposed to an x-ray dose of approximately 0.03 Joules from an x-ray source of 6 KV, 12 mA, for between approximately 2 milliseconds and 2 seconds.

4. A solution of polyvinylferrocene in chlorobenzene is deposited over substrate surfaces. The substrates are kept in contact via exposure to pressure and exposed to an x-ray dose of approximately 0.03 Joules from an x-ray source of 6 kV, 12 mA, for between approximately 2 milliseconds and 2 seconds.

5. A solution of polybutadiene-1-sulfone in a mixture of cyclohexanone and methylethylcetone 1:1 is deposited over substrate surfaces. The substrates are kept in contact via exposure to pressure and exposed to an x-ray dose of approximately 0.03 Joules from an x-ray source of 6 kV, 12 mA, for between approximately 2 milliseconds and 2 seconds.

6. A solution of epoxypolybutadiene in a mixture of 4 parts of methylethylcetone and 1 part xylene is deposited over substrate surfaces. The substrates are kept in contact via exposure to pressure and exposed to an x-ray dose of approximately 0.03 Joules from an x-ray source of 6 kV, 12 mA, for between approximately 2 milliseconds and 2 seconds.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An adhesive, photosensitive composition comprising:
a first compound comprising a member selected from the group consisting of a monomer, a crosslinkable polymer, and a combination thereof; and
a second compound that generates free radicals capable of initiating polymerization upon exposure to a source of x-rays.

2. The composition of claim 1 wherein said monomer is polymerizable.

3. The composition of claim 1 wherein said polymer forms cross links and said monomer polymerizes upon exposure to x-rays.

4. The composition of claim 1 wherein said second compound comprises a member selected from the group consisting of boron trifluoride di-ethyletherate, paratoluenesulfonic acid, 2,2 azobis(2methyl propionitrile), and a combination thereof.

5. The composition of claim 1 further comprising a solvent.

6. The composition of claim 5 further comprising a binder soluble in said solvent.

7. The composition of claim 6 wherein the binder comprises a binder polymer selected from the group consisting of polyurethanes, polystyrenes, polybutadienes, copolymers of styrene, butadienes, and a combination thereof.

8. The composition of claim 7 wherein the binder polymer is hydrophobic and not photodegradable by x-rays.

9. The composition of claim 1 comprising said cross linkable polymer and said monomer in a ratio of from between approximately 35 and 22:1, respectively.

10. The composition of claim 1 wherein the monomer and crosslinkable polymer comprise members selected from the group consisting of polymers such as polyacrilics, polystyrenes, polyvinylesthers, spiroorthoesthers, bicicloorhoesthers, their co-polymers, and a combination thereof.

11. The composition of claim 1 wherein the monomer comprises a polyacrilate selected from the group consisting of methylmethacrylate, allylmethacrylate, hydroxyethylmethacrylate, dichloropropylacrylate, phenylmethacrylate, acrylic acid, ethylacrylate, glycidylmethacrylate, and a combination thereof.

12. The composition of claim 1 wherein the monomer comprises a chloromethylstyrene.

13. The composition of claim 1 wherein the monomer comprises a polyvinylesther selected from the group consisting of 2-chloroethylvinylether, ethylvinylether, isobutylvinylether, vinylferrocene, and a combination thereof.

14. The composition of claim 1 wherein the monomer comprises a member selected from the group consisting of spiroorthoesthers, bicicloorthoesters, and a combination thereof.

15. The composition of claim 14 wherein the spiroorthoesther is selected from the group consisting of 2-hydroxymethyl-1,4,6-trioxaspiro[4,6]undecane, 2-methylene-1,4,6-trioxaspiro[4,6]undecane, 2-allyloxymethyl-1,4,6-trioxaspiro[4,6]undecane, 2-methacryloxymethyl-1,4,6-trioxaspiro[4,6]undecane, and a mixture thereof.

16. The composition of claim 14 wherein the bicicloorthoesther is selected from the group consisting of 1-ethyl-4-hydromethyl-2,6,7-trioxabiciclo[2,7,7]octane, 4-ethylvinyl-2,6,7-trioxabiciclo[2,7,7]octane, and a combination thereof.

17. The composition of claim 1 wherein the monomer comprises a member selected from the group consisting of butane-1-sulfone, di-allylorthophtalate, and a combination thereof.

18. The composition of claim 1 wherein the crosslinkable polymer comprises a member selected from the group consisting of polymethacrylate, polyhydroxyalkylmethacrylate, polyphenylamethacrylate, acrylic acid, polyallylmethacrylate, polyhydroxyethylmethacrylate, polyglycidilmethacrylate, polyethylacrylate, Zn polymethacrylate, polydiaryl-ophtalmic acid, Zn acrylate, triarylisocyanurate, and a combination thereof.

19. A method for adhering materials together, said method comprising:
combining a first compound comprising a member selected from the group consisting of a monomer, a crosslinkable polymer, and a combination thereof with a second compound that generates free radicals capable of initiating polymerization upon exposure to a source of x-rays to form a photosensitive compound;
disposing the photosensitive composition between two substrates to be adhered to one another; and
exposing the photosensitive composition to x-rays so that the photosensitive compound polymerizes to adhere the two substrates together.

20. The method of claim 19 further comprising disposing the photosensitive composition between the two substrates in a layer of from between approximately 60 and 200 microns.

21. The method of claim 19 further comprising exposing the photosensitive composition to x-rays from an x-ray source of approximately 6 kV and 12 mA

22. The method of claim 19 further comprising exposing the photosensitive composition to an x-ray does of approximately 0.03 Joules.

23. The method of claim 19 further comprising exposing the photosensitive composition to an x-ray dose for a time of from between approximately 50 microseconds to 4 seconds.

24. An assembly comprising:
a first material;
a second material; and
a photosensitive adhesive composition disposed between said first material and said second material, said photosensitive adhesive composition polymerizable upon exposure to x-rays.

25. The assembly of claim 24 wherein said photosensitive adhesive composition comprises:
a first compound comprising a member selected from the group consisting of a polymerizable monomer, a crosslinkable polymer, and a combination thereof, said monomer polymerizable upon exposure to x-rays and said polymer crosslinkable upon exposure to x-rays; and
a second compound that generates free radicals capable of initiating polymerization upon exposure to a source of x-rays.

26. The assembly of claim 24 wherein said first material comprises a footwear upper material and said second material comprises a footwear sole.
